(19) United States
(12) Patent Application Publication
(10) Pub. No.: US 2026/0313525 A1
(43) Pub. Date: Oct. 8, 2026

(54) WIRELESS COMMUNICATION APPARATUS, METHOD OF CONTROLLING WIRELESS COMMUNICATION APPARATUS, AND STORAGE MEDIUM

(71) Applicant: CANON KABUSHIKI KAISHA, Tokyo (JP)

(72) Inventor: ATSUSHI IKEDA, Kanagawa (JP)

(21) Appl. No.: 19/637,678

(22) Filed: Apr. 2, 2026

(30) Foreign Application Priority Data
Apr. 8, 2025 (JP) 2025-063581

(51) Int. Cl. H04W 48/16

(52) U.S. Cl. CPC H04W 48/16

(57) ABSTRACT

A communication apparatus according to the present disclosure can perform communication in a 2.4 GHz band, a 5 GHz band, and a 6 GHz band. The communication apparatus receives an instruction from a user, performs control to perform first connection processing using Wi-Fi protected setup (WPS) in a case where a first instruction is received from the user and to perform second connection processing not using WPS in a case where a second instruction is received from the user, and scans a plurality of channels by using a first frame not including information on WPS. In a case where the control is performed to perform the first connection processing, the scan is performed using channels in the 2.4 GHz band and channels in the 5 GHz band, and the scan is not performed using channels in the 6 GHz band.

### BACKGROUND

### Field of the Technology

The present disclosure relates to a wireless communication apparatus, a method of controlling the wireless communication apparatus, and a storage medium.

### Description of the Related Art

In recent years, the number of cases where a wireless communication function is mounted on electronic apparatuses such as a digital camera, a printer, a mobile phone, and a smartphone, and these apparatuses are used by being connected to a wireless network is increasing. In particular, the number of cases where communication between the apparatuses is performed using a wireless local area network (LAN) as the wireless communication function is increasing.

To connect the electronic apparatus to the wireless network, it is necessary to set various communication parameters such as an encryption method, an encryption key, an authentication method, and an authentication key. As a technique for facilitating setting of these communication parameters, there is a Wi-Fi protected setup (WPS) standard in which communication parameters for accessing the wireless network are shared in response to pressing of a button.

In WPS, a connection source apparatus is referred to as an enrollee, and a connection destination apparatus is referred to as a registrar. In a case where a user presses a button for starting WPS connection processing in the enrollee, the enrollee performs scan processing for searching for a connection destination. The scan processing used herein means acquisition of a list of registrars (e.g., connection destinations) to which the enrollee (e.g., connection source) can be connected.

The scan processing in a Wi-Fi connection procedure normally performs searching by using all frequency bands (e.g., channels) usable by the connection source apparatus. The channels usable by the connection source apparatus include channels in a 2.4 GHz band and a 5 GHz band.

A technique for controlling whether to use channels in the 5 GHz band for connection, based on performance of the connection source apparatus in the Wi-Fi connection procedure is described (see Japanese Patent Laid-Open No. 2019-036793).

The technique described in Japanese Patent Laid-Open No. 2019-036793 solves issues when the connection source apparatus uses a low-end wireless chip set and can use a plurality of wireless communication modes. The wireless communication modes supported by the technique described in Japanese Patent Laid-Open No. 2019-036793 are an infrastructure mode in Wi-Fi connection and a peer-to-peer (P2P) mode.

In a case where the low-end wireless chip set is used in the apparatus, there is a case where it is necessary to use the same channel of the W-Fi connection in the infrastructure mode and the P2P mode. In the following, this restriction is referred to as a first restriction. Further, in the P2P mode, there is a case where the 5 GHz band cannot be used as the channel of the Wi-Fi connection. In the following, this restriction is referred to as a second restriction.

In the technique described in Japanese Patent Laid-Open No. 2019-036793, in consideration of the above-described first restriction and second restriction, in a case where the connection source apparatus operates in the P2P mode, only the 2.4 GHz band is usable. On the other hand, in a case where the connection source apparatus operates in only the infrastructure mode, any of the 2.4 GHz band and the 5 GHz band is usable.

By the way, the Ministry of Internal Affairs and Communications has authorized use of a 6 GHz band as a frequency band (e.g., channel) in the Wi-Fi connection in September 2022. As a result, Wi-Fi 6E that is a standard for using channels in the 6 GHz band is established, and apparatuses supporting Wi-Fi 6E have been popularized.

Further, in 2024, Wi-Fi 7 that is a standard supporting multilink connection has been established. The multilink is a standard allowing simultaneous use of a plurality of channels in the 2.4 GHz band, the 5 GHz band, and the 6 GHz band.

Therefore, in recent years, the number of apparatuses supporting both WPS and Wi-Fi 7 is increasing.

WPS does not support connection using the 6 GHz band. In a case where an apparatus supporting both WPS and Wi-Fi 7 starts connection using WPS, the scan processing is performed in the 2.4 GHz band, the 5 GHz band, and the 6 GHz band. However, since WPS does not support connection using the 6 GHz band, the scan processing in the 6 GHz band is wasteful. In addition, there is an issue that the scan processing in the 6 GHz band is high in processing load, and causes an increase in scan time.

The technique described in Japanese Patent Laid-Open No. 2019-036793 controls whether to use the channels in the 5 GHz band for connection, based on the above-described first restriction and second restriction, but cannot cope with a case where restriction is not particularly present. Further, the channels in the 6 GHz band are not described in Japanese Patent Laid-Open No. 2019-036793, and the above-described issues cannot be solved.

In a case where the channels in the 6 GHz band cannot be used in the apparatus supporting both WPS and Wi-Fi 7, convenience is impaired in multilink connection not using WPS.

Therefore, it is desirable to provide a technique for controlling frequency bands (e.g., channels) used for the scan processing based on whether to use the WPS standard.

### SUMMARY

The present disclosure is directed to a mechanism for performing efficient scan processing in an apparatus that can perform communication in a 2.4 GHz band, a 5 GHz band, and a 6 GHz band.

To solve the above-described issues, the present disclosure includes the following configuration. According to an aspect of the present disclosure, a communication apparatus performing communication in a 2.4 GHz band, a 5 GHz band, and a 6 GHz band including at least one memory that stores a set of instructions, and at least one processor that executes the instructions, the instructions, when executed, causing the communication apparatus to perform operations including receiving an instruction from a user, performing control to perform first connection processing using Wi-Fi protected setup (WPS) in a case where the receiving receives a first instruction from the user, and to perform second connection processing not using WPS in a case where the receiving receives a second instruction from the user, and scanning a plurality of channels by using a first frame not including information on WPS, wherein, in a case where the controlling performs control to perform the first connection processing, the scanning performs the scan by using channels in the 2.4 GHz band and channels in the 5 GHz band, and does not perform the scan by using channels in the 6 GHz band.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a configuration of a wireless communication system to which the present disclosure is applicable.

FIG. 2 illustrates a configuration of a printer.

FIG. 3 illustrates a configuration of a smartphone.

FIG. 4 is a flowchart for switching channels used for scan processing in the printer in response to user operation according to a first embodiment.

FIG. 5A illustrates a display example of buttons of the printer.

FIG. 5B illustrates a display example of a pop-up displaying supplemental explanation of a list selection button.

FIG. 6 is a flowchart for displaying a pop-up in the printer according to a first modification.

FIG. 7 is a flowchart in a case where when the printer is started up, scan processing is started according to a second embodiment.

FIG. 8 is a flowchart in a case where when the printer is started up, scan processing is started according to a second modification.

FIG. 9A illustrates a display example of a pop-up displaying restriction in connection processing of the printer.

FIG. 9B illustrates another display example of the pop-up displaying restriction in connection processing of the printer.

FIG. 10A illustrates a display example of a pop-up displaying a state of the printer.

FIG. 10B illustrates another display example of the pop-up displaying the state of the printer.

### DESCRIPTION OF THE EMBODIMENTS

A wireless communication apparatus according to each of the embodiments is described below with reference to drawings. The technical scope of the present disclosure is defined by claims, and is not limited by the following embodiments. The technical scope of the present disclosure may be appropriately corrected or changed depending on a configuration of an apparatus to which the present disclosure is applied, and various kinds of conditions.

### First Embodiment

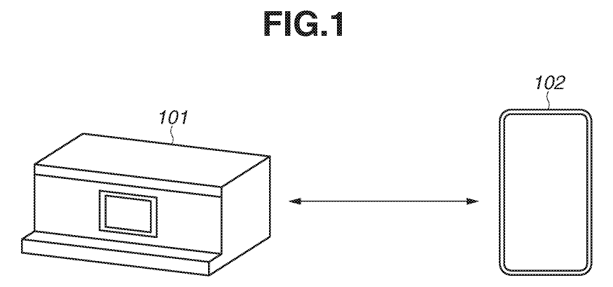

FIG. 1 illustrates a configuration of a wireless communication system to which the present disclosure is applicable. In FIG. 1, a printer 101 and a smartphone 102 are illustrated. In the present embodiment, the printer 101 and the smartphone 102 can communicate with each other by using a wireless local area network (LAN) and short-range wireless communication. Further, the printer 101 and the smartphone 102 can communicate with each other by using the wireless LAN using Wi-Fi protected setup (WPS) or multilink.

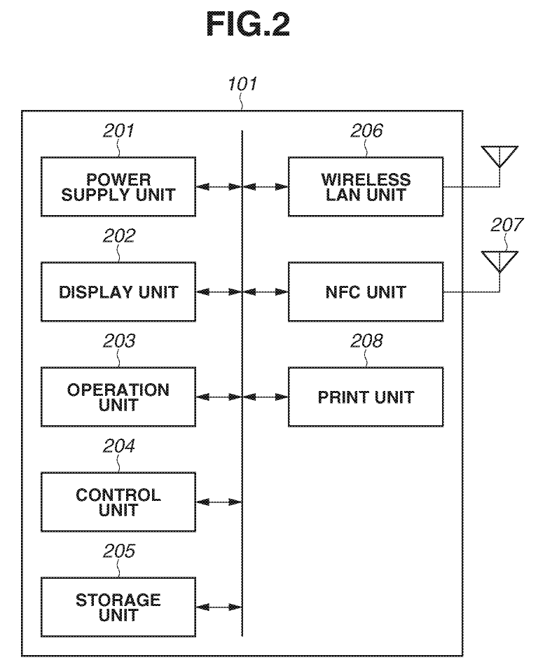

FIG. 2 illustrates a configuration of the printer 101. A power supply unit 201, a display unit 202, an operation unit 203, a control unit 204, a storage unit 205, a wireless LAN unit 206, a near field communication (NFC) unit 207, and a print unit 208 are illustrated in FIG. 2.

The power supply unit 201 supplies power to each of the units. For example, the power supply unit 201 acquires power from an alternating-current (AC) power supply.

The display unit 202 controls various kinds of display for a user. For example, the display unit 202 includes a light-emitting diode (LED), and performs display control on a screen.

The operation unit 203 receives various kinds of operation from the user. For example, the operation unit 203 includes buttons. Both the display unit 202 and the operation unit 203 may be configured by one module like a touch panel.

The control unit 204 includes a processor such as a central processing unit (CPU) and a microprocessor unit (MPU), and controls the entire printer 101 by executing programs stored in the storage unit 205.

The storage unit 205 includes memories such as a read only memory (ROM) and a random access memory (RAM), and stores programs for performing various kinds of processing described below, and various kinds of information.

The wireless LAN unit 206 performs wireless LAN control compliant with an Institute of Electrical and Electronics Engineers (IEEE)802.11 standard and a Wi-Fi standard, and performs transmission/reception of radio waves. The wireless LAN unit 206 includes a wireless LAN module and an antenna. The wireless LAN unit 206 serves as a terminal station in an infrastructure mode of the IEEE802.11 standard, and can be connected to another terminal station through an access point to perform mutual communication. Further, the wireless LAN unit 206 serves as a base station or a terminal station of WPS, and can be connected to another terminal station or base station to perform mutual communication.

The NFC unit 207 performs NFC control compliant with NFC standards such as ISO/IEC 14443, ISO/IEC 15693, and ISO/IEC 18092, and performs transmission/reception of radio waves. The NFC unit 207 includes an NFC module and an antenna.

The print unit 208 performs printing on a print medium such as paper. The print unit 208 includes a printer head, a driving device of the printer head, and ink.

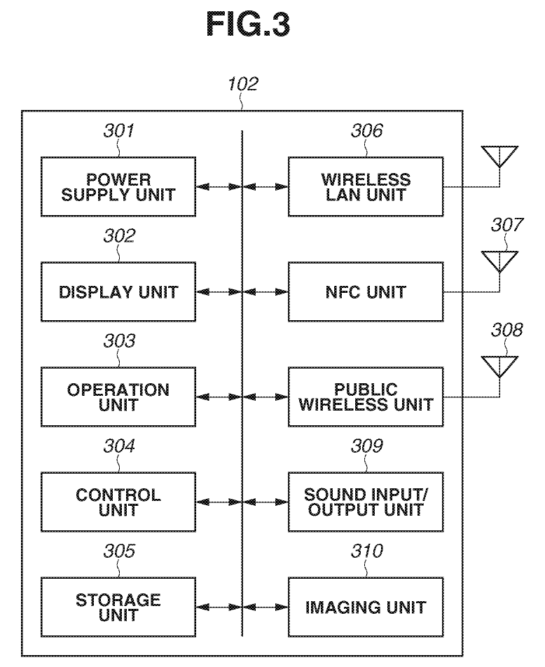

FIG. 3 illustrates a configuration of the smartphone 102. A power supply unit 301, a display unit 302, an operation unit 303, a control unit 304, a storage unit 305, a wireless LAN unit 306, an NFC unit 307, a public wireless unit 308, a sound input/output unit 309, and an imaging unit 310 are illustrated in FIG. 3.

The power supply unit 301 supplies power to each of the units. For example, the power supply unit 301 acquires power from a battery.

The display unit 302 performs various kinds of display for the user. For example, the display unit 302 includes an LED, and performs display on a screen.

The operation unit 303 receives various kinds of operation from the user. For example, the operation unit 303 includes buttons. Both the display unit 302 and the operation unit 303 may be configured by one module like a touch panel.

The control unit 304 includes processors such as a CPU and an MPU, and controls the entire smartphone 102 by executing programs stored in the storage unit 305. The storage unit 305 includes memories such as a ROM and a RAM, and stores programs for performing various kinds of processing described below, and various kinds of information.

The wireless LAN unit 306 performs wireless LAN control compliant with the IEEE802.11 standard and the Wi-Fi standard, and performs transmission/reception of radio waves. The wireless LAN unit 306 includes a wireless LAN module and an antenna. The wireless LAN unit 306 serves as a terminal station in the infrastructure mode of the IEEE802.11 standard, and is connected to another terminal station through an access point to perform mutual communication. Further, the wireless LAN unit 306 serves as a base station or a terminal station of WPS, and is connected to another terminal station or base station to perform mutual communication.

The NFC unit 307 performs NFC control compliant with NFC standards such as ISO/IEC 14443, ISO/IEC 15693, and ISO/IEC 18092, and performs transmission/reception of radio waves. The NFC unit 307 includes an NFC module and an antenna.

The public wireless unit 308 performs public wireless control complying with, for example, an international multimedia telecommunications (IMT) standard and a long term evolution (LTE) standard, and performs transmission/reception of radio waves. The public wireless unit 308 includes a public wireless module and an antenna.

The sound input/output unit 309 performs input/output of sound for the user to make a call, and includes a microphone, a speaker, and the like.

The imaging unit 310 captures a still image and a moving image, and includes an image sensor and a lens.

In the present embodiment, a form is described in which, in a case where the user operates the printer 101, channels in scan processing are controlled in response to an instruction by the user.

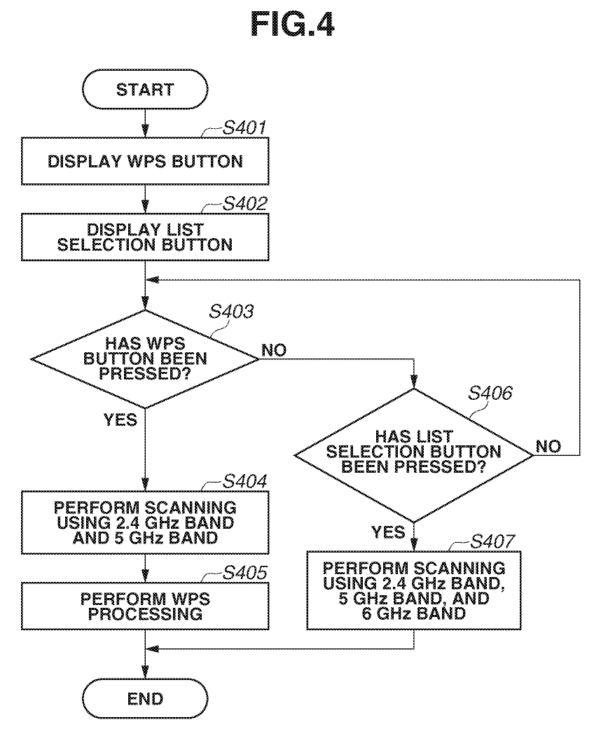

FIG. 4 is a flowchart for determining channels used in the printer 101 according to the present embodiment. First, in step S401 in FIG. 4, the display unit 202 displays a WPS button. In a case where the user presses the WPS button, connection using WPS is started.

In the present embodiment, the WPS button is described as a button in a user interface (UI) display; however, the WPS button is not limited thereto. For example, the WPS button may be a physical button provided on a housing of the printer 101. In this case, step S401 may be omitted.

Next, in step S402 in FIG. 4, the display unit 202 displays a list selection button. In a case where the user presses the list selection button, a connection not using WPS, such as multilink connection is started, and connection destination candidates found in the scan processing are displayed in a list format.

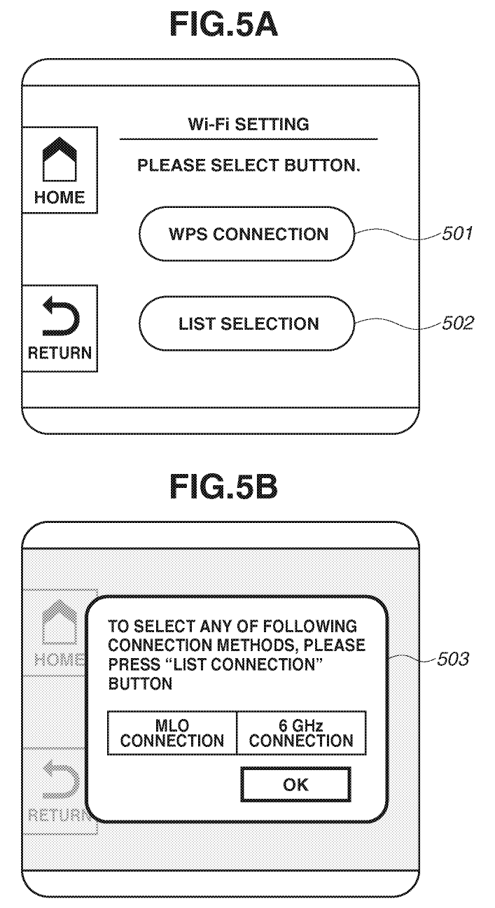

In this example, the WPS button and the list selection button are displayed in different steps; however, the display unit 202 may be configured to display the WPS button and the list selection button at a time as illustrated in FIG. 5A.

FIG. 5A illustrates a display example of items of the WPS button and the list selection button. FIG. 5A illustrates examples of a UI and items displayed on the screen of the printer 101. A WPS button 501, and a list selection button 502 are illustrated in FIG. 5A.

In step S403, the control unit 204 determines whether the user has pressed the WPS button. In a case where the user has pressed the WPS button as a result of determination in step S403 (YES in step S403), the wireless LAN unit 206 performs the scan processing using a plurality of channels in the 2.4 GHz band and the 5 GHz band in step S404. Further, in step S405, the wireless LAN unit 206 performs WPS processing.

More specifically, the wireless LAN unit 206 transmits a Probe Request frame including a Device Password ID of a Wi-Fi simple configuration information element (WSC IE).

In contrast, in a case where the user has not pressed the WPS button as a result of determination in step S403 (NO in step S403), the control unit 204 determines whether the user has pressed the list selection button in step S406. In a case where the user has pressed the list selection button as a result of determination in step S406 (YES in step S406), the wireless LAN unit 206 performs the scan processing using a plurality of channels in the 2.4 GHz band, the 5 GHz band, and the 6 GHz band in step S407.

More specifically, the wireless LAN unit 206 transmits a Probe Request frame not including a Device Password ID of a WSC IE.

In contrast, in a case where the user has not pressed the list selection button as a result of determination in step S406 (NO in step S406), the processing returns to step S403.

As described above, the processing proceeds to step S404 or S407 in response to pressing of the WPS button in step S403 or the list selection button in step S406 by the user.

As described in the present embodiment, the channels used for the scan processing are switched based on whether the user desires connection by WPS or a connection method other than WPS, which makes it possible to control the channels appropriate for the connection method.

### First Modification

As a modification of the first embodiment, an example in which a pop-up for explaining a function of a button is displayed subsequent to display of the button is described. In the first embodiment, the example in which a text "WPS connection" is displayed on the WPS button, and a text "list connection" is displayed on the list selection button is described. However, the user may not understand processing to be performed, only from the text "list connection". Therefore, in the present modification, an example in which supplemental explanation of the list selection button is displayed as a pop-up is described.

FIG. 5B illustrates a display example of the pop-up. FIG. 5B illustrates an example of a UI displayed on the screen of the printer 101. A pop-up 503 displays supplemental explanation of the list selection button. The user can know from the pop-up 503 that, in a case where the user desires multilink connection or 6 GHz connection, the user presses the list selection button.

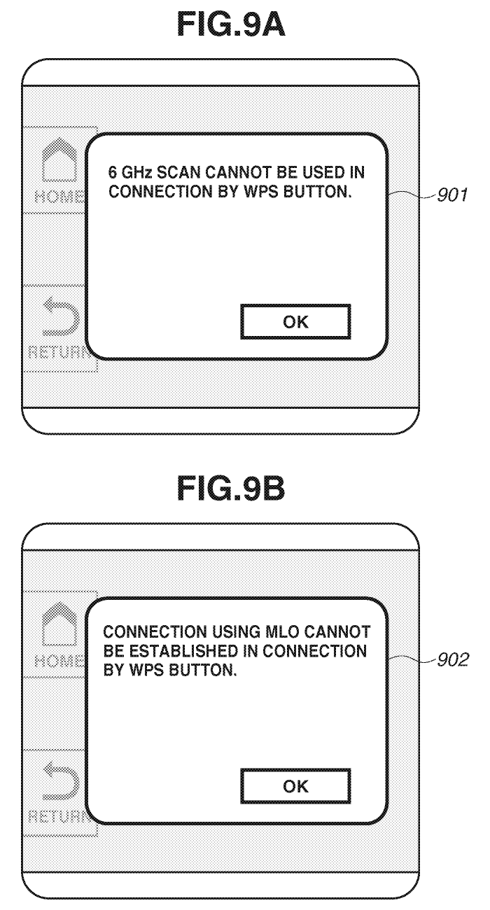

Further, at this time, another pop-up for explaining restriction of each button may be displayed. FIGS. 9A and 9B each illustrate an example of a pop-up for explaining restriction of each button. FIG. 9A illustrates a pop-up for explaining restriction relating to scan processing performed by the WPS button. FIG. 9B illustrates a pop-up for explaining another restriction relating to the scan processing performed by the WPS button.

In FIG. 9A, a pop-up 901 displays that "6 GHz scan cannot be used in connection by WPS button", and the user can know that 6 GHz scan cannot be performed in connection by the WPS button.

In FIG. 9B, a pop-up 902 displays that "connection using MLO cannot be established in connection by WPS button", and the user can know that multi-link operation (MLO) cannot be used in connection by the WPS button.

One of the pop-up illustrated in FIG. 9A and the pop-up illustrated in FIG. 9B may be displayed. Alternatively, the pop-up illustrated in FIG. 9A and the pop-up illustrated in FIG. 9B may be sequentially displayed, or may be displayed at the same time.

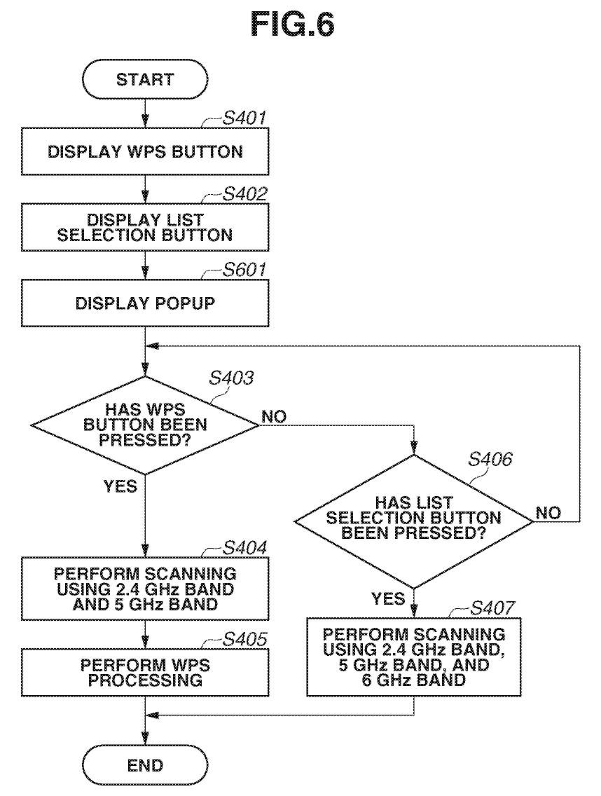

FIG. 6 is a flowchart for displaying the pop-up 503 on the display unit 202 of the printer 101 in the present modification. The flowchart illustrated in FIG. 6 and the flowchart illustrated in FIG. 4 are different in that the pop-up 503 is displayed on the display unit 202 in step S601 after step S402 in FIG. 6.

### Second Embodiment

In a second embodiment, a case where, when an apparatus is started up, 6 GHz scan processing is started by a Wi-Fi connection procedure not using WPS is considered. An example in which control is performed to stop the 6 GHz scan processing, in response to pressing of the WPS button is described.

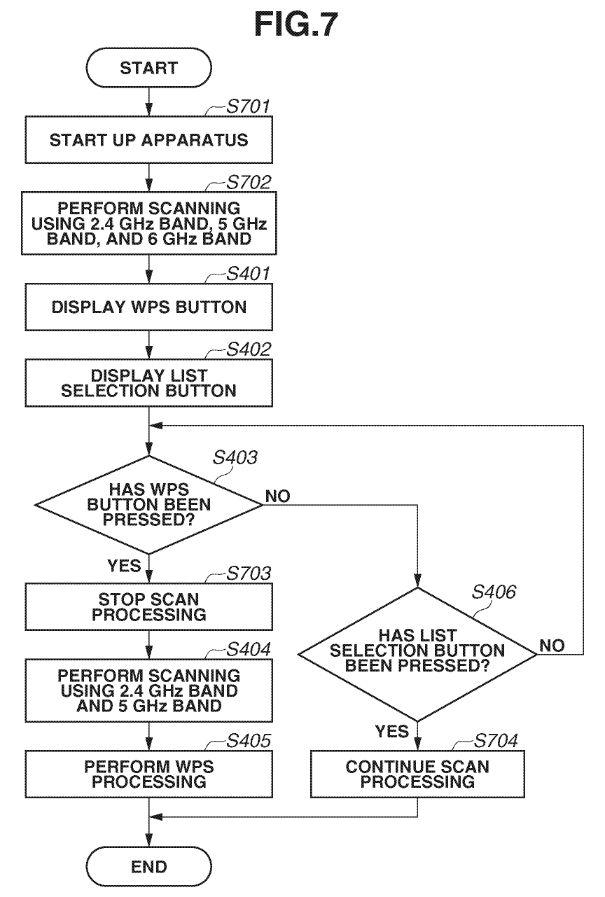

FIG. 7 is a flowchart for switching channels used in the printer 101 according to the present embodiment. In step S701 in FIG. 7, the apparatus is first started up by the power supply unit 201. Next, in step S702, the wireless LAN unit 206 performs the scan processing using a plurality of channels in the 2.4 GHz band, the 5 GHz band, and the 6 GHz band. The processing in step S702 is the same as the processing in step S407. Subsequently, the processing proceeds to step S401.

In the processing in and after step S401, the flowchart illustrated in FIG. 7 and the flowchart illustrated in FIG. 4 are different in processing in a case where the user presses the WPS button and processing in a case where the user presses the list selection button.

In step S403, in a case where it is determined that the user has pressed the WPS button (YES in step S403), the wireless LAN unit 206 stops the scan processing in step S703. By stopping the scan processing once, the scan processing can be switched to scan processing not using the channels in the 6 GHz band in step S404.

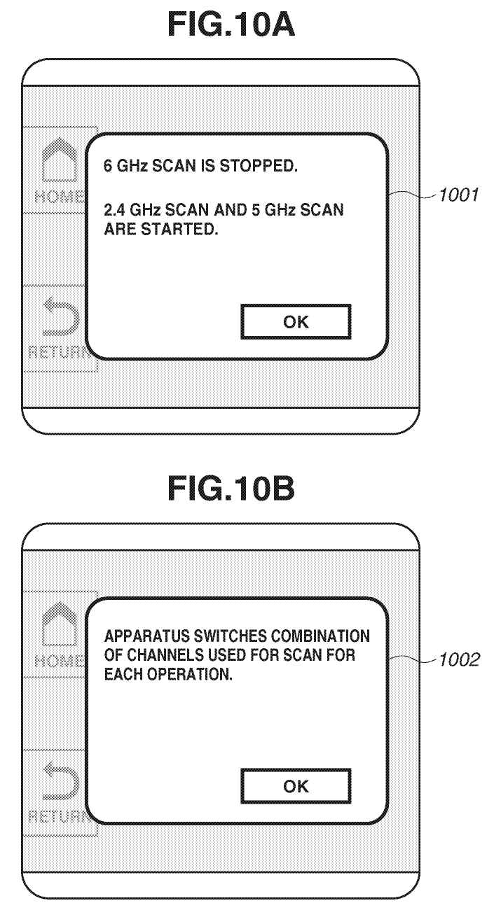

FIG. 10A illustrates an example of a pop-up for explaining to the user that channels used for the scan processing are switched at this time. In FIG. 10A, a pop-up 1001 displays that "6 GHz scan is stopped. 2.4 GHz scan and 5 GHz scan are started.". Therefore, the user can know that, when the user presses the WPS button, 6 GHz scan is stopped.

FIG. 10B illustrates another example of the pop-up for explaining to the user that channels used for the scan processing are switched at this time. In FIG. 10B, a pop-up 1002 displays that "apparatus switches combination of channels used for scan for each operation.". Therefore, the user can know that, when the user presses any of the buttons, the channels used until then are switched to other channels.

One of the pop-up illustrated in FIG. 10A and the pop-up illustrated in FIG. 10B may be displayed. Alternatively, the pop-up illustrated in FIG. 10A and the pop-up illustrated in FIG. 10B may be sequentially displayed, or may be displayed at the same time.

In a case where it is determined in step S406 that the user has pressed the list selection button (YES in step S406), the wireless LAN unit 206 continues the scan processing in step S704. In FIG. 4, in this case, the scan processing is started in step S407; however, in FIG. 7, the scan processing is already started in step S702, and therefore, the scan processing is continued.

As a result, even when the scan processing using the channels in the 6 GHz band is already under execution, the scan processing can be switched to scan processing not using the channels in the 6 GHz band as in WPS, in response to request by the user.

### Second Modification

In a second modification, a case where when the printer is started up, the scan processing not using the channels in the 6 GHz band is started is considered. An example in which control is performed to stop the scan processing already started, in response to pressing of the list selection button is described.

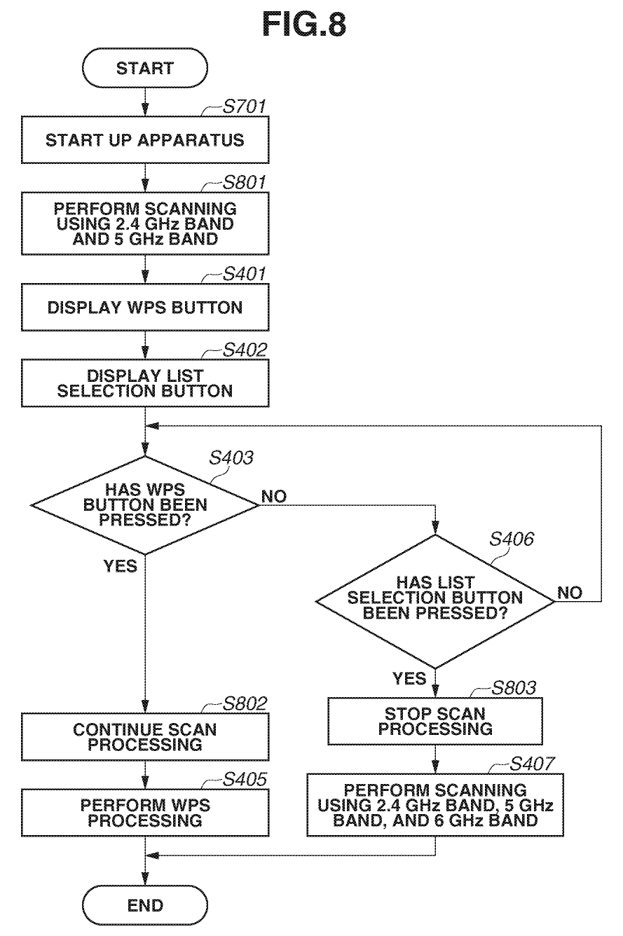

FIG. 8 is a flowchart for switching channels used in the printer 101 according to the present modification. The flowchart illustrated in FIG. 7 and the flowchart illustrated in FIG. 8 are different in channels used for the scan processing performed when the apparatus is started up, processing in a case where the user presses the WPS button, and processing in a case where the user presses the list selection button.

In FIG. 8, in step S801 after step S701, the wireless LAN unit 206 performs the scan processing using the channels in the 2.4 GHz band and the 5 GHz band.

Further, in FIG. 8, in a case where it is determined in step S403 that the user has pressed the WPS button (YES in step S403), the wireless LAN unit 206 continues the scan processing in step S802. Since the scan processing is already started in step S801 in FIG. 8, the scan processing is continued.

Next, in a case where it is determined in step S406 that the user has pressed the list selection button during execution of the scan processing (YES in step S406), the wireless LAN unit 206 stops the scan processing in step S803. Further, the processing proceeds to step S407, and the wireless LAN unit 206 performs the scan processing using the channels in the 2.4 GHz band, the 5 GHz band, and the 6 GHz band. By stopping the scan processing once, the scan processing can be switched to scan processing using the channels in the 6 GHz band in step S407.

The disclosure is not limited to the above-described embodiments, and can be variously changed and modified without departing from the spirit and the scope of the disclosure. Therefore, to apprise the public of the scope of the disclosure, the following claims are made.

According to the present disclosure, the apparatus that can perform communication in the 2.4 GHz band, the 5 GHz band, and the 6 GHz band can perform efficient scan processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063581, filed April 8, 2025, which is hereby incorporated by reference herein in its entirety.

What is claimed is:

1. A communication apparatus performing communication in a 2.4 GHz band, a 5 GHz band, and a 6 GHz band, the communication apparatus comprising:
at least one memory that stores a set of instructions; and
at least one processor that executes the instructions, the instructions, when executed, causing the communication apparatus to perform operations comprising:
receiving an instruction from a user;
performing control to perform first connection processing using Wi-Fi protected setup (WPS) in a case where the receiving receives a first instruction from the user, and to perform second connection processing not using WPS in a case where the receiving receives a second instruction from the user; and
scanning a plurality of channels by using a first frame not including information on WPS,
wherein, in a case where the controlling performs control to perform the first connection processing, the scanning performs the scan by using channels in the 2.4 GHz band and channels in the 5 GHz band, and does not perform the scan by using channels in the 6 GHz band.

2. The communication apparatus according to claim 1, wherein, in a case where the second connection processing is performed, the scanning performs the scan by using the channels in the 2.4 GHz band, the channels in the 5 GHz band, and the channels in the 6 GHz band.

3. The communication apparatus according to claim 2, wherein the information on WPS is a Wi-Fi simple configuration information element (WSC IE).

4. The communication apparatus according to claim 1,
wherein the operations further comprising performing control to display a first screen including a first item and a second item, and
wherein the receiving receives the first instruction in response to selection of the first item by the user, and receives the second instruction in response to selection of the second item by the user.

5. The communication apparatus according to claim 4, wherein, in a case where the first item is selected, the first screen displays that connection processing is not performed in the 6 GHz band.

6. The communication apparatus according to claim 4, wherein, in a case where connection processing in the 6 GHz band is desired, the first screen displays a message for prompting selection of the second item.

7. The communication apparatus according to claim 4, wherein, in a case where the first item is selected, the first screen displays that connection using multi-link operation (MLO) is not performable.

8. The communication apparatus according to claim 4, wherein, in a case where connection using MLO is desired, the first screen displays a message for prompting selection of the second item.

9. The communication apparatus according to claim 1, wherein, in a case where the first connection processing is performed while the scan is performed using the channels in the 2.4 GHz band, the channels in the 5 GHz band, and the channels in the 6 GHz band, the scanning is stopped.

10. The communication apparatus according to claim 1, wherein, in a case where the controlling performs control to perform the second connection processing while the scan is performed using the channels in the 2.4 GHz band and the channels in the 5 GHz band, the scanning is stopped.

11. A method of controlling a communication apparatus performing communication in a 2.4 GHz band, a 5 GHz band, and a 6 GHz band, the method comprising:
receiving an instruction from a user;
performing control to perform first connection processing using WPS in a case where a first instruction is received from the user, and to perform second connection processing not using WPS in a case where a second instruction is received from the user; and
scanning a plurality of channels by using a first frame not including information on WPS,
wherein, in a case where the control is performed to perform the first connection processing, the scan is performed using channels in the 2.4 GHz band and channels in the 5 GHz band, and the scan is not performed using channels in the 6 GHz band.

12. A non-transitory computer-readable storage medium storing instructions that, when executed by a computer, cause the computer to perform a method of controlling a communication apparatus performing communication in a 2.4 GHz band, a 5 GHz band, and a 6 GHz band, the method comprising:
receiving an instruction from a user;
performing control to perform first connection processing using WPS in a case where a first instruction is received from the user, and to perform second connection processing not using WPS in a case where a second instruction is received from the user; and
scanning a plurality of channels by using a first frame not including information on WPS,
wherein, in a case where the control is performed to perform the first connection processing, the scan is performed using channels in the 2.4 GHz band and channels in the 5 GHz band, and the scan is not performed using channels in the 6 GHz band.
